(19) United States
(12) Patent Application Publication
(10) Pub. No.: US 2013/0246188 A1
(43) Pub. Date: Sep. 19, 2013

(54) SYSTEM AND METHOD FOR PROVIDING SOCIAL NETWORK SERVICE

(71) Applicant: Man-Ik Chang, Seoul (KR)

(72) Inventor: Man-Ik Chang, Seoul (KR)

(21) Appl. No.: 13/885,833

(22) PCT Filed: Nov. 14, 2011
(86) PCT No.: PCT/KR2011/008679

§ 371 Date: May 16, 2013

(30) Foreign Application Priority Data
Nov. 22, 2010 (KR) 10-2010-0116064
Dec. 28, 2010 (KR) 20100136203

(51) Int. Cl. G06F 17/30

(52) U.S. Cl. CPC G06F 17/30094; G06Q 30/0269
USPC 705/14.66; 707/608

(57) ABSTRACT

Provided are a method and system for providing a social network service that is connected to at least one subscriber terminal over a network. According to the present invention, a user may set up a goal in his/her life and put activities into practice. The user may apply other subscribers' life contents to himself/herself while viewing them during setting up the goal or putting the activities into practice, as needed. Comments from other users may function as catalyst in changing subscribers' mind and behaviors to live happily and successfully.

### BACKGROUND OF THE INVENTION

1. Field of the Invention

The present invention relates to a social network service, and more particularly, to a system and method for providing a social network service that enable a user to create and practice life contents by himself/herself over a social network, and to share his/her life contents with other users, and facilitate bidirectional communication between a user and an advertiser to increase the efficiency and effect of an advertisement.

2. Description of the Related Art

Recently, ways of providing and using web contents has quickly changed. When the web contents has started being provided at first, a few professional providers have created and provided most of the contents and numerous ordinary users just has used the provided contents as used in typical media.

However, with the advent of Web 2.0 that emphasizes the participation and cooperation of users, general users has also participated in creating the contents and the creation/usage of the contents without a distinct classification between a producer and a user is recently accelerated on blogs or sharing sites.

Thus, user created contents are sharply increasing in importance in the whole web. Such user created contents are mainly found on blogs, micro blogs, web forums, picture or video sharing sites, etc. and in addition, many users creates contents by themselves through social network platforms. Due to an explosive increase in such user created contents, a technology to provide contents of a good quality to users through search or recommendation on a large amount of contents is needed.

People want to live successfully and happily. However, living so is very difficult. Some people set up goals at the begging of the year or when there is something desired, and put these into practice but some people do not.

Recently, most people are widely using inventive digital equipment such as a smart phone or a tablet PC and it is possible to process various tasks, e.g., to manage their schedules or check their emails by using such equipment.

Typical social network services just enable relation formation and information exchange. The amount of contents (information, materials, etc.) exchanged over the internet has remarkably increased as compared to that of contents exchanged through offline services in the past but there are some limitations in distribution of redundant contents, low quality of distributed contents, unproductive information utilization by a user who is a member of a social network, etc.

The current social network service is limited to relation formation, information exchange, etc. and focuses on commercial utilization based on the number of subscribers. Thus, there is a limit in performing functions of achieving comprehensive life goal and objective of a user participating in the social network service.

As such, the typical social network service has focused on distributing interest-oriented or simple information, in which process redundant distribution of similar contents, a decrease in quality of distributed contents, social side effect due to a strong addictive characteristic, and unproductive information utilization by a user who is a member of the social network are pointed out as limitations.

Paths to access customers increase due to an increase in advertising media and a development of in interactive media technology such as the internet enables real-time communication between a customer and a company. It is possible to see various kinds of advertising messages everywhere on/off line throughout 24 hours due to the diversity of such advertising media and the development of an information technology.

However, most customers avoid commercial advertisements and thus an advertiser does not obtain an effect according to the expenditure of an advertising cost.

In particular, since a typical online advertisement shows an advertisement suitable for web page contents which a user searches to obtain information, there is a limit in accurately matching the intention and interest of a user. In addition, since the user basically avoids commercial advertisements, the efficiency and effect of an advertisement are in doubt. Further, there is basically a limit in focusing only on a search activity among several daily activities of a user, setting up target audience, and providing an advertisement.

### SUMMARY OF THE INVENTION

Accordingly, in order to substantially obviate one or more problems due to limitations and disadvantages of the related art, the present invention provides a system and method for providing a social network service that enable users to set up and put their goals into practice, help them to live desired life by receiving evaluations on the practice, and enable utilizing life contents of other users and evaluating other users.

In addition, the present invention enables a social network service to settle on a future-oriented, creative, and productive on/off line space. Also, a user who participates in the social network service just is not a consumer of contents but functions as a creator (producer), a provider, and a consumer of contents. Accordingly, the user may be a leader of his/her life to achieve his/her distinct life vision. Also, the present invention enables the social network service to contribute to increasing social benefits as well as expanding commercial market values.

Also, the present invention is directed to a system and method for providing a social network service that enable a user and an advertiser to make bidirectional communication with an advertisement associated with an activity from which the intension and interest of a social network user may be read, and show information required by the user step by step without focusing only on promoting a product or a service of the advertiser in providing the advertisement to increase understanding on the advertiser and acceptance toward an advertisement. That is, the present invention is directed to a system and method for providing a social network service that increase the effect and efficiency of an advertisement in a professional manner in which knowledge suitable for interests of users, company introduction and an advertisement are sequentially provided.

According to an embodiment of the present invention, a system for providing a social network service is connected to at least one subscriber terminal over a network and includes a subscriber profile database (DB) that stores profile information including biography, goals, and activities of the subscriber; a social interchange field DB that stores public profile information of the subscriber profile information; a catalyst DB that stores at least one of comment information regarding the activity and ceremony information; and a control unit that receives a goal in life and activities to achieve the goal from the subscriber terminal, creates or updates the social interchange field of the subscriber and provides at least one of activity information, social interchange field information, comment information corresponding to the activity, and ceremony information corresponding to a goal achieving process of another user depending on a selection of the subscriber terminal.

The control unit may include a subscriber managing unit that processes an authentication of the subscriber terminal; a social interchange field control unit that receives a goal in life and activities to achieve the goal from the subscriber terminal, and updates the social interchange field of the subscriber; and an information providing unit that provides at least one of activity information, social interchange field information, comment information corresponding to the activity, and ceremony information corresponding to a goal achieving process of another user depending on a selection of the subscriber terminal.

According to another embodiment of the present invention, a system for providing a social network service is connected to at least one subscriber terminal over a network and includes a subscriber profile DB that stores profile information including biography, goals, and activities of the subscriber; a social interchange field DB that stores public profile information of the subscriber profile information; a catalyst DB that stores at least one of comment information regarding the activity and ceremony information; a knowledge DB 324 that stores knowledge information corresponding to a kind of the activities; a vision DB that stores vision information corresponding to the knowledge information; a product advertising DB that stores advertisement information regarding a product corresponding to the vision information; and a control unit that receives a goal in life and activities to achieve the goal from the subscriber terminal, creates or updates the social interchange field of the subscriber, provides at least one of activity information, social interchange field information, comment information corresponding to the activity, and ceremony information corresponding to a goal achieving process of another user depending on a selection of the subscriber terminal, and provides at least one of the knowledge information corresponding to the activity, the vision information, and the product advertising information when providing the activity information.

The control unit may include a subscriber managing unit that processes an authentication of the subscriber terminal; a social interchange field control unit that receives a goal in life and activities to achieve the goal from the subscriber terminal, and updates the social interchange field of the subscriber; an information providing unit that provides at least one of activity information, social interchange field information, comment information corresponding to the activity, and ceremony information corresponding to a goal achieving process of another user depending on a selection of the subscriber terminal; and an advertisement control unit that provides at least one of the knowledge information corresponding to the activity, the vision information, and the product advertising information when providing the activity information.

According to another embodiment of the present invention, a method of providing a social network service by a social network service providing system including a database unit and a control and connected to at least one subscriber terminal over a network, includes receiving information including subscriber's biography, goal, and activity from the subscriber by the control unit, creating a social interchange field for storing life contents, and storing the created field in the database unit; classifying an activity by using a tag function if the activity is input from the subscriber terminal; and updating information regarding the activity on the database unit by the control unit.

The method may further include providing a given ceremony depending on the input activity.

According to another embodiment of the present invention, a method of providing a social network service by a social network service providing system including a database unit and a control and connected to at least one subscriber terminal over a network, includes providing menu information to the subscriber terminal by the control unit; providing, by the control unit, activities of all subscribers with reference to the database unit if the subscriber terminal selects to view all activities; providing, by the control unit, recent activities of social interchange fields of all subscribers with reference to the database unit if the subscriber terminal selects to view all social interchange fields; and providing a social interchange field corresponding to an activity if the activity is selected.

The method may further include receiving a comment corresponding to the activity in response to a selection of the terminal and storing the received comment in the database unit.

According to another embodiment of the present invention, a method of providing a social network service by a social network service providing system including a database unit and a control and connected to at least one subscriber terminal over a network, includes providing menu information to the subscriber terminal by the control unit; providing some of at least one of activities of all subscribers, knowledge information corresponding to the activities, vision information, and product advertising information with reference to the database unit if the subscriber terminal selects to view all activities; providing, by the control unit, some of at least one of recent activities of social interchange fields of all subscribers, knowledge information corresponding to the activities, vision information, and product advertising information with reference to the database unit if the subscriber terminal selects to view all social interchange fields; and providing all of selected information if some of at least one of the knowledge information, the vision information, and the product advertising information are selected.

The method may further include sequentially providing the knowledge information, the vision information, and the product advertising information, if some of at least one of the knowledge information, the vision information, and the product advertising information are selected.

The method may further include linking to a web page for leading to a purchase procedure if purchasing is selected after the product advertising information is provided.

### BRIEF DESCRIPTION OF THE DRAWINGS

FIG. 1 is a schematic diagram of a system for providing a social network service according to a first embodiment of the present invention;

FIG. 2 is an operational flow chart of a method of providing a social network service according to a first embodiment of the present invention;

FIGS. 3 to 7 are exemplary views of screens according to a method of providing a social network service according to a first embodiment of the present invention;

FIG. 8 is a schematic diagram of a system for providing a social network service according to a second embodiment of the present invention;

FIG. 9 is an operational flow chart of a method of providing a social network service according to a second embodiment of the present invention; and

FIGS. 10 and 11 are exemplary views of screens according to a method of providing a social network service according to a second embodiment of the present invention.

### DETAILED DESCRIPTION OF THE INVENTION

Hereinafter, preferred embodiments of the present invention will be described with reference to the accompanying drawings to fully explain the present invention in such a manner that it may easily be carried out by a person with ordinary skill in the art to which the present invention pertains. However, the present invention may be implemented in several different forms and is not limited to embodiments to be described below. Also, descriptions on some parts in the drawings are omitted to clearly describe the present invention, and like reference numerals are attached to like parts throughout the specification.

Throughout the specification, when some parts “include” or “have” some components, it should be understood that it may comprise (or include or has) only those elements, or it may comprise (or include or have) other elements as well as those elements if there is no specific limitation. In addition, the terms “˜unit”, “˜group”, and “˜module” indicate a unit to process at least one function or operation and it may be implemented in hardware, in software, or in a combination of hardware and software.

A terminal 100 to be described below digital equipment such as personal digital assistant (PDA), a smart phone, a feature phone, a notebook computer, a tablet PC and a PC with which a user may use an internet service.

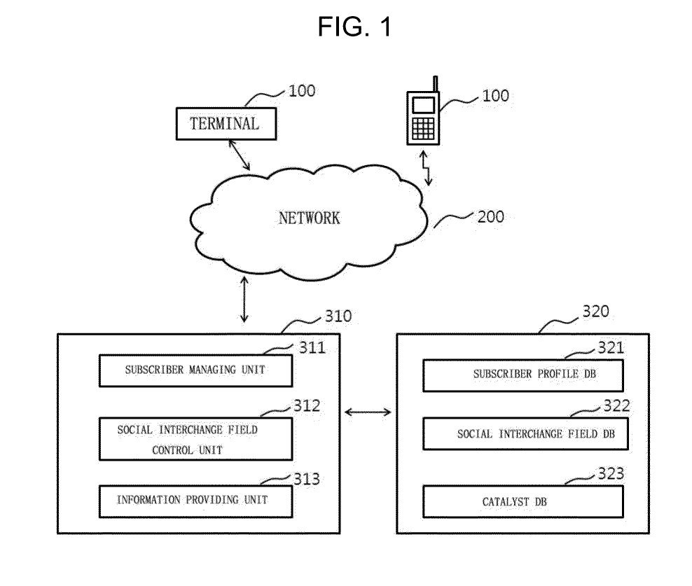

FIG. 1 is a schematic diagram of a system for providing a social network service according to a first embodiment of the present invention.

Referring to FIG. 1, the system for providing a social network service according to a first embodiment of the present invention is connected to at least one subscriber terminal 100 over a network. The system includes a subscriber profile DB 321 that stores profile information including biography, goals, and activities of the subscriber; a social interchange field DB 322 that stores public profile information of the subscriber profile information; a catalyst DB 323 that stores at least one of a comment regarding the activity and ceremony information; and a control unit 310 that receives a goal in life and activities to achieve the goal from the subscriber terminal, creates or updates the social interchange field of the subscriber and provides at least one of an activity, social interchange field, a comment corresponding to the activity, and ceremony corresponding to a goal achieving process of another user depending on a selection of the subscriber terminal.

The control unit 310 includes a subscriber managing unit 311 that processes authentication of the subscriber terminal; a social interchange field control unit 312 that receives a goal in life and activities to achieve the goal from the subscriber terminal, and updates the social interchange field of the subscriber; and an information providing unit 313 that provides at least one of an activity, social interchange field, a comment corresponding to the activity, and ceremony corresponding to a goal achieving process of another user depending on a selection of the subscriber terminal.

The control unit 310 may function to remove negative elements from the mind of a user if necessary, may enable a user to set up a goal, may present mentor information to enable the user to plan a particular activity for achieving the goal, may analyze how close the user has reached to the goal if the user has input an activity which has been put into practice in daily life and may then provide ceremony. Detailed components that make up the control unit 310 and a DB unit 320 are functionally classified but may function as one unit if necessary.

Then, the operation of the system for providing a social network service will be described below in more detail.

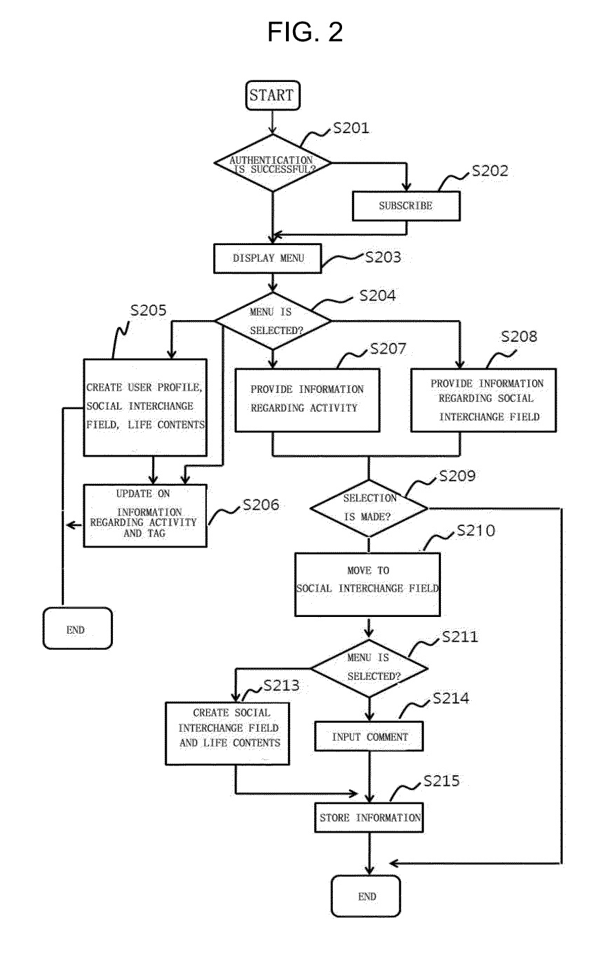

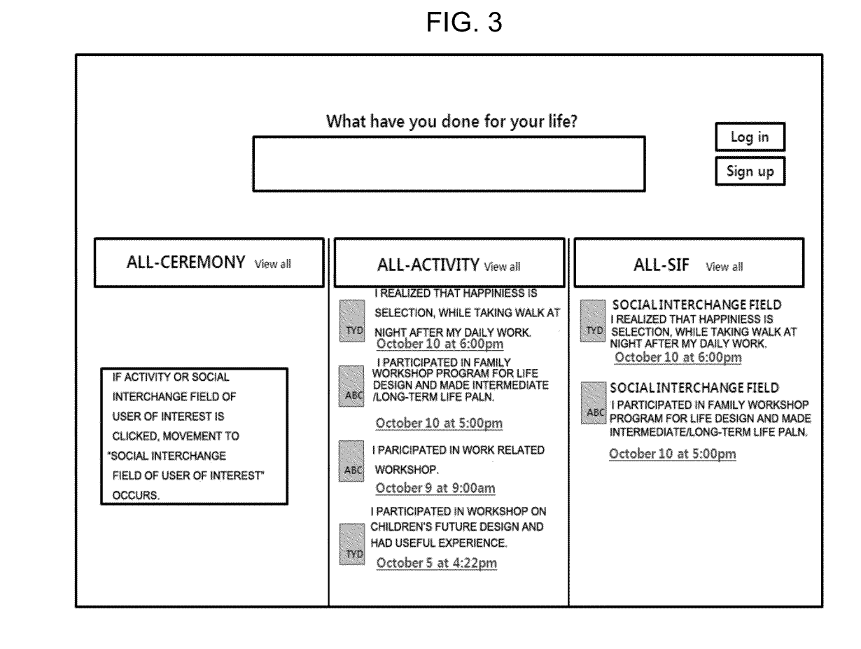

FIG. 2 is an operational flow chart of the process of creating the social interchange field in a method of providing a social network service according to a first embodiment of the present invention, and FIGS. 3 to 7 are exemplary views of screens according to a method of providing a social network service according to a first embodiment of the present invention.

A user and a subscriber have the same meaning, the user indicates a person before subscription, and the subscriber indicates a person after subscription.

Referring to FIG. 2, a user uses his/her terminal to connect to the control unit 310 functioning as a web server over a network. Since it is known that the user may see a web page provided by a given web server, through his/her terminal's screen if the user connects to the given web server by using his/her terminal 100, a related detailed description is not provided.

Then, the subscriber managing unit 311 provides an initial screen as shown in FIG. 3 and several variations on such a screen may be made.

Next, the subscription managing unit 311 receives an ID and a password from the terminal and performs an authentication procedure in step S201.

If the user does not have an ID or a password, the subscriber managing unit 311 performs a subscription procedure by receiving member information from the terminal 100, creating subscriber profile, and storing input information.

Subsequently, the information providing unit 313 provides menu information in step S203. Such menu information may be always provided on various display screens.

Then, if a subscriber selects a menu for creating a social interchange field, the social interchange field control unit 312 receives a goal in life from the subscriber terminal 100, creates a social interchange field for that subscriber, and stores the social interchange field in the social interchange field DB 322, and such information is also stored in the subscriber profile DB 321, in step S205.

In this case, the social interchange field control unit 312 makes detailed profile information including subscriber's life contents (dreams, how-to, intermediate objectives (IOs), activities) as needed, and activities functioning as the results of user's actual practice are input and updated to user profile and the social interchange field. The user profile includes dreams of a user being a member of a social network, how-to, IOs, and activity streams for achieving the dreams, and the same matters are also included in the social interchange field. Thus, it is possible to integrate the user profile and the social interchange field into one element and operate the integrated element.

The user being a member of the social network classifies actually performed activities based on life contents that he/she has made, according to a classification criterion. If the activities are made public, related updates are simultaneously performed on his/her user profile and the social interchange field, and if they are not made public, related updates are performed only on his/her user profile.

In addition, the social interchange field control unit 312 may provide and set ceremony information from the subscriber terminal 100 depending on a process for achieving a goal even if the goal itself is not been achieved yet. For example, if a desired period is three months and activities corresponding to one, two, and three months are input, each of first, second, third ceremonies may differ from one another. In some cases, it is also possible to provide ceremonies on a weekly basis. The ceremony is a behavior indicating celebration and may involve various actions. Ceremony information may be stored in the catalyst DB 323.

If the subscriber selects a menu for inputting activities in step S206, the social interchange filed control unit 312 receives activities performed to achieve a goal, from the subscriber terminal 100, and receives the kind of the activities in a tag function. In this case, the tag may be classified into various items such as life, education, assets, business, etc. and a user may personally input the items or may select them.

The social interchange field control unit 312 stores the received activities in the subscriber profile DB 321 and also stores in the social interchange filed DB 322 if the activities are for public use. In some cases, the social interchange field control unit 312 may be selectively stored in the subscriber profile DB 321 or the social interchange field DB 322.

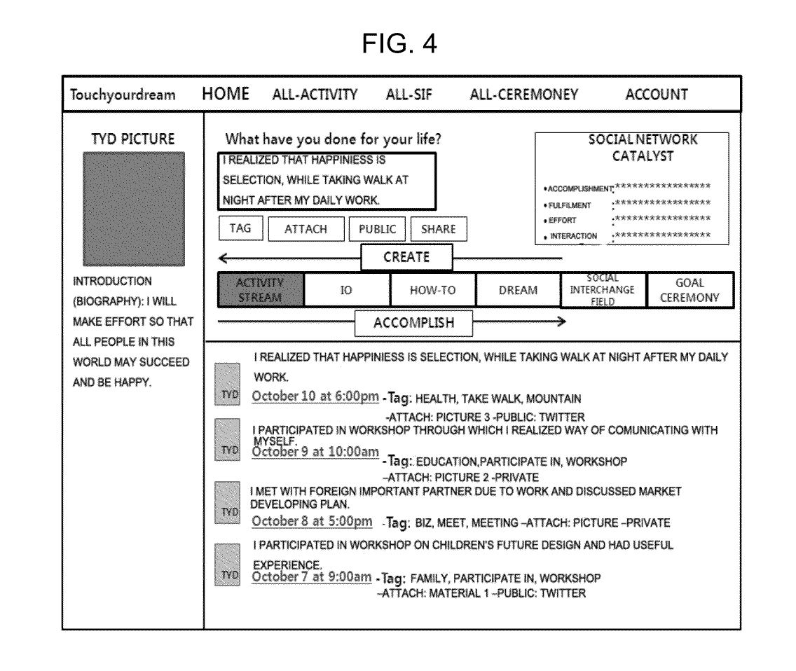

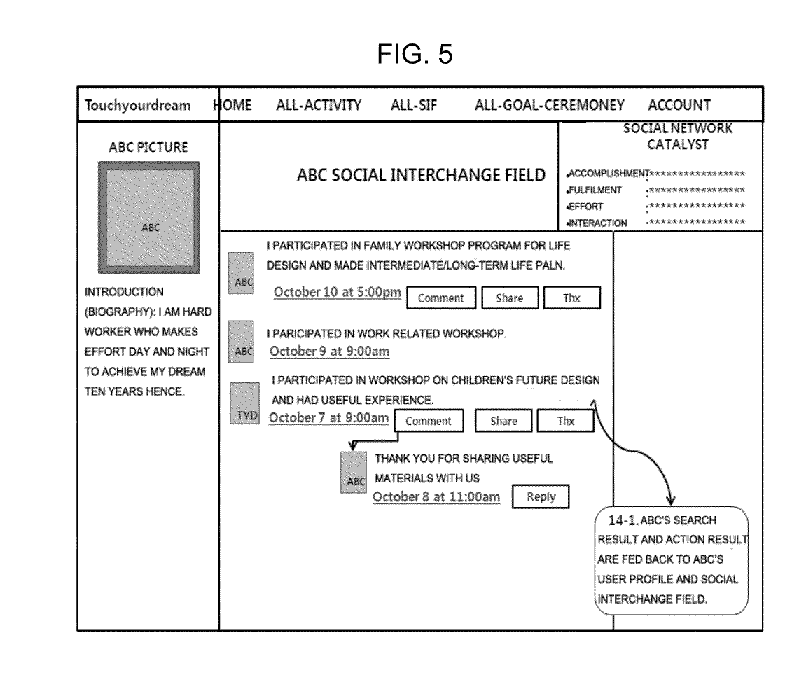

An update is performed to a screen as shown in FIG. 4 or FIG. 5 to provide it to the terminal 100 and an input is performed through a screen as shown in FIG. 4. An input activity is posted with tag information which is also stored in the social interchange field DB 322. FIG. 4 is a subscriber profile screen, FIG. 5 is a social interchange field screen, a movement to each screen is made by using a menu, and such a menu selection may be performed in various ways.

It is possible to attach moving pictures, still pictures, etc. as needed to an activity and if a corresponding attached file is selected, the social interchange field control unit 312 reads and provides a corresponding file from the subscriber profile DB 321 or the social interchange field DB 322.

If the subscriber terminal selects viewing all activities, the information providing unit 313 provides recent activities with reference to the social interchange field DB 322 and this type corresponds to a type that is obtained by expanding all activities of FIG. 3 in step S207. In this case, recent ones of activities input by all users are displayed in order. That is, the top activity is the most recent activity.

In addition, if the subscriber terminal selects viewing all social interchange fields, the information providing unit 313 provides simple information regarding social interchange fields of all users with reference to the social interchange field DB 322, in which case one recent activity is provided per social interchange field instep S208. A restriction on a screen display causes the simple information which indicates a subscriber's ID and a subscriber's goal.

If desired activities are selected from such activities in step S209, the information providing unit 313 provides a social interchange field of a selected activity owner in step S210.

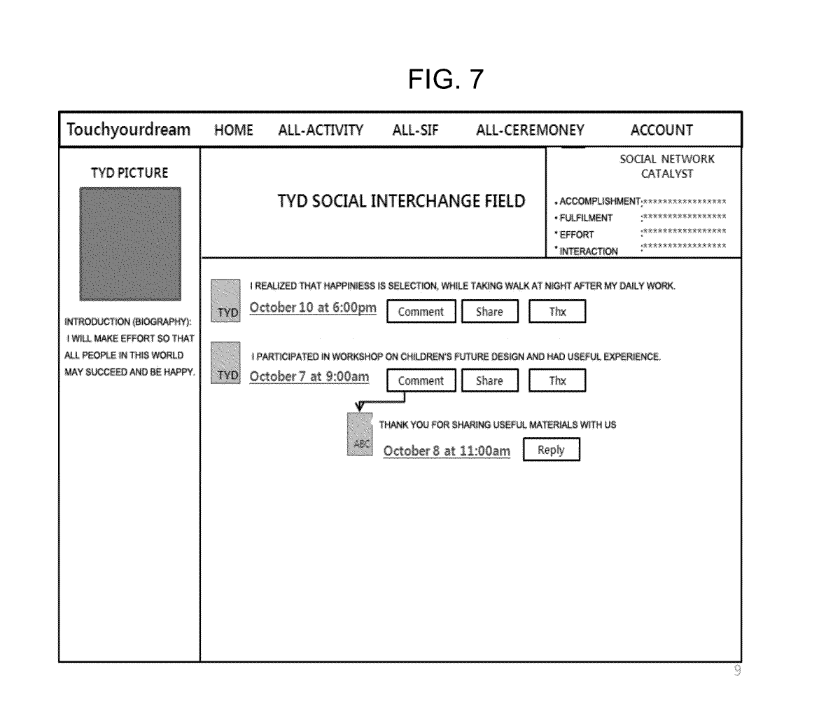

An example of such a screen is provided in FIG. 7 and while the subscriber views the goal or the activities in the social interchange field as shown in FIG. 7, he/she may input comments corresponding the activities in step S214 depending on his/her selection in step S211. The information providing unit 313 receives the comments and stores them in the catalyst DB 323 in step S215 if the comments are input. In this case, the comments function as catalyst and if comments are received from other users, subscribers may have a strong will to achieve his/her goal and have pleasure in performing activities due to encouragement from other users. In some cases, an operator may provide a separate benefit of such a comment. For example, it is possible to provide Dotory functioning as cyber money, free gifts and points. In addition, the social network catalyst may analyze user's activities in terms of accomplishment (how much life contents have been accomplished), fulfillment (how much life contents have been fulfilled), effort (how hard a user makes an effort to achieve life contents), and interaction (how deeply user's important experiences and wisdom will be shared with other users) and may feed the analyzed results back to a user. Accordingly, active social communication is facilitated among social network members, and it is possible to monitor and evaluate behaviors of members, and feed the results back so that each member achieves his/her life contents.

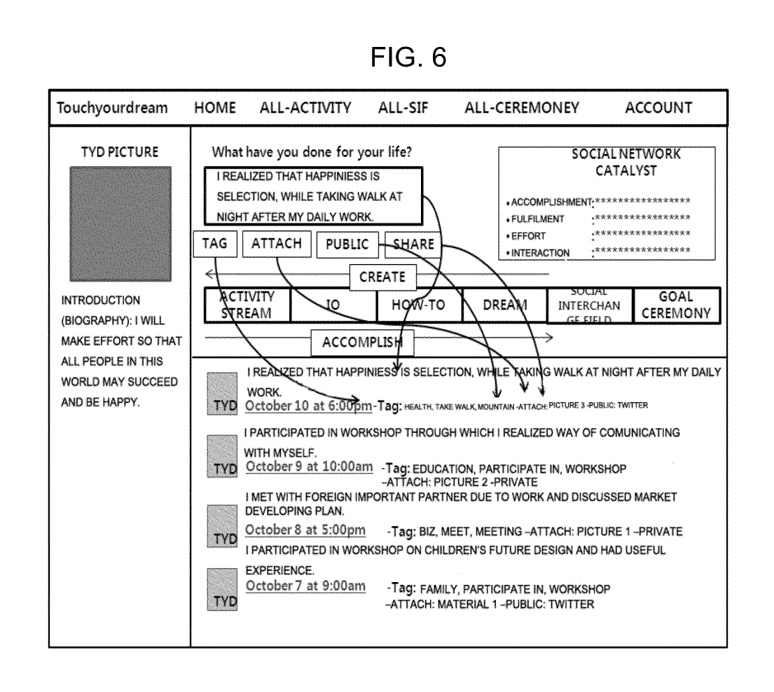

In addition, it is possible to make public profile as shown in FIG. 6 and use comments or other functions as shown in FIG. 7 as needed.

In addition, a user may select a share menu, use and vary a social interchange field of other users to create his/her social interchange field or life contents in step S213.

If the social interchange field is created in this way, the social interchange field control unit 312 stores it in the social interchange field DB 322 in step S215.

Also, the user may select some or all of his/her contents as public or private to protect his/her privacy. In this case, the information providing unit 313 provides information regarding public social interchange fields to users.

Referring back to FIG. 5 or FIG. 7, the social interchange field includes public contents of users being social network members, and the users being the social network members may make active social communication between users in the social interchange field. In addition, the accomplishment, the fulfillment, the effort, and the interaction may be provided as evaluation items, in which case the accomplishment may be determined based on a period, the fulfillment may be determined based on the number of activities, and the effort and the interaction may be determined based on the number of comments that a user has provided to other users. Such matters may vary as needed. In addition, the information providing unit 313 indicates by arrows in profile information how much a user's goal has been achieved, which makes the user easy to know how much the user's goal has been achieved.

The process of selecting a menu may be performed through a screen any time as needed, and an input entry such as an activity and a comment is updated after input operations on the subscriber profile DB 321 and the social interchange field DB 322 and thus users may immediately view updated activities or comments.

Such a first embodiment may make several variations and among others, an embodiment integrated into an advertisement will be described.

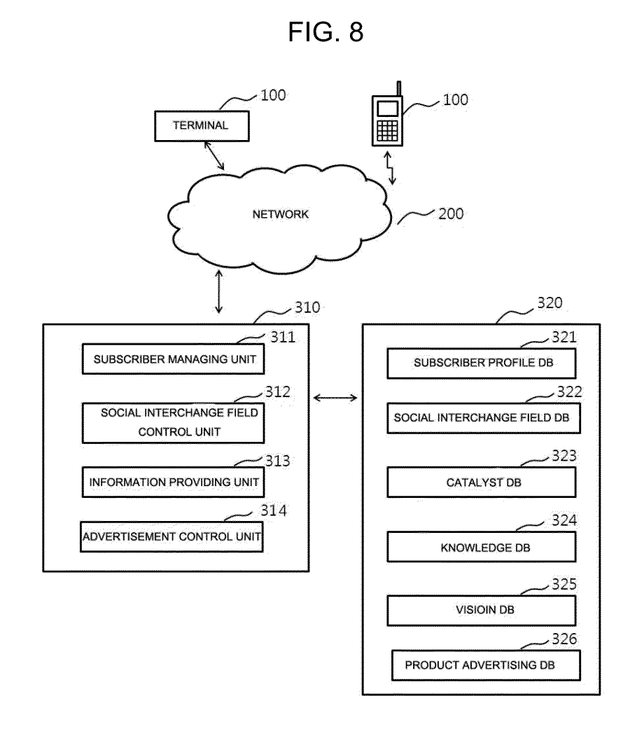

FIG. 8 is a schematic diagram of a system for providing a social network service according to a second embodiment of the present invention.

Referring to FIG. 8, the system for providing a social network service according to a second embodiment of the present invention is connected to at least one subscriber terminal 100 over a network. The system includes a subscriber profile DB 321 that stores profile information including biography, goals, and activities of the subscriber; a social interchange field DB 322 that stores public profile information of the subscriber profile information; a catalyst DB 323 that stores at least one of a comment regarding the activity and ceremony information; a knowledge DB 324 that stores knowledge information corresponding to the kind of the activities; a vision DB (325) that stores vision information corresponding to the knowledge information; a product advertising DB 326 that stores advertising information regarding a product corresponding to the vision information; and a control unit 310 that receives a goal in life and activities to achieve the goal from the subscriber terminal, creates or updates the social interchange field of the subscriber, provides at least one of an activity, social interchange field, a comment corresponding to the activity, and ceremony corresponding to a goal achieving process of another user depending on a selection of the subscriber terminal, and provides at least one of the knowledge information corresponding to the activity, the vision information, and the product advertising information when providing the activity information.

The control unit 310 includes a subscriber managing unit 311 that processes authentication of the subscriber terminal; a social interchange field control unit 312 that receives a goal in life and activities to achieve the goal from the subscriber terminal, and updates the social interchange field of the subscriber; an information providing unit 313 that provides at least one of an activity, social interchange field, a comment corresponding to the activity, and ceremony corresponding to a goal achieving process of another user depending on a selection of the subscriber terminal; and an advertisement control unit 314 that provides at least one of the knowledge information corresponding to the activity, the vision information, and the product advertising information when providing the activity information.

The second embodiment is made by adding the advertisement control unit 314 to the first embodiment, and in the present embodiment, the database unit 320 further includes the knowledge DB 324, the vision DB 325, and the product advertising DB 326, and functions other than the further functions are substantially the same to those of the first embodiment.

Then, the operation of the system for providing a social network service according to the second embodiment will be described in more detail, and matters that are not provided in the first embodiment will be mainly described.

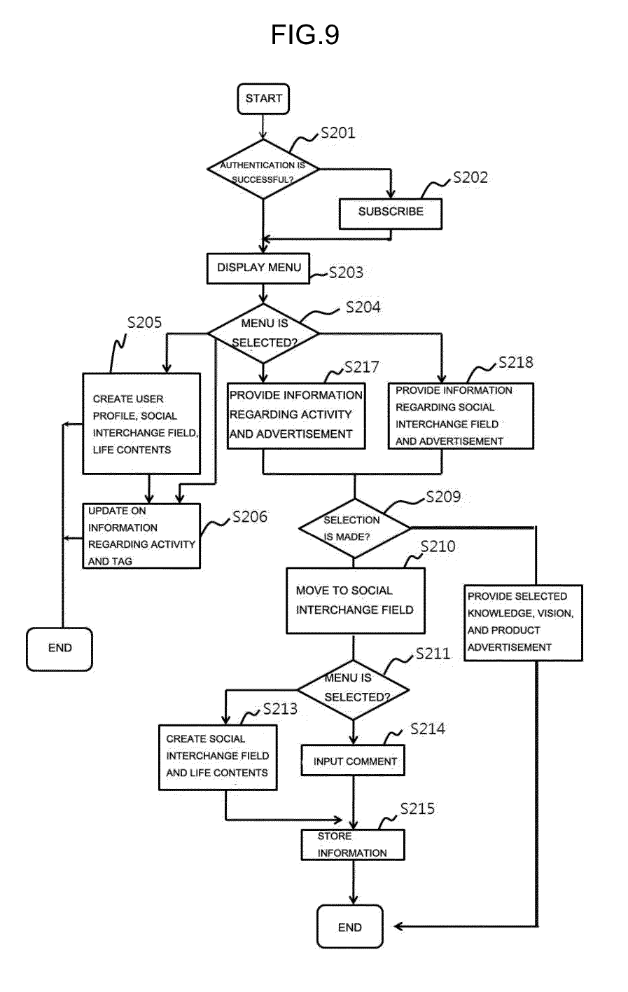

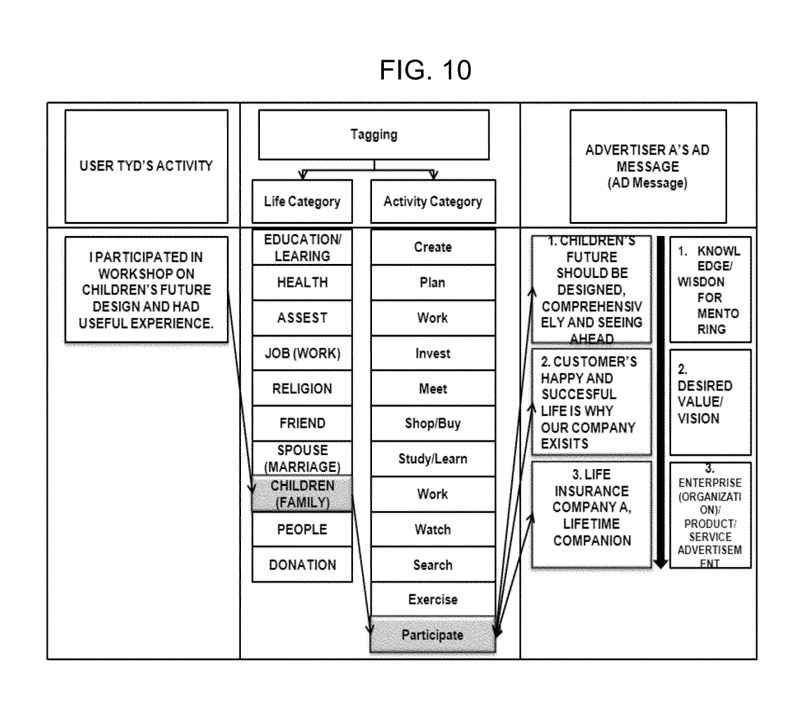

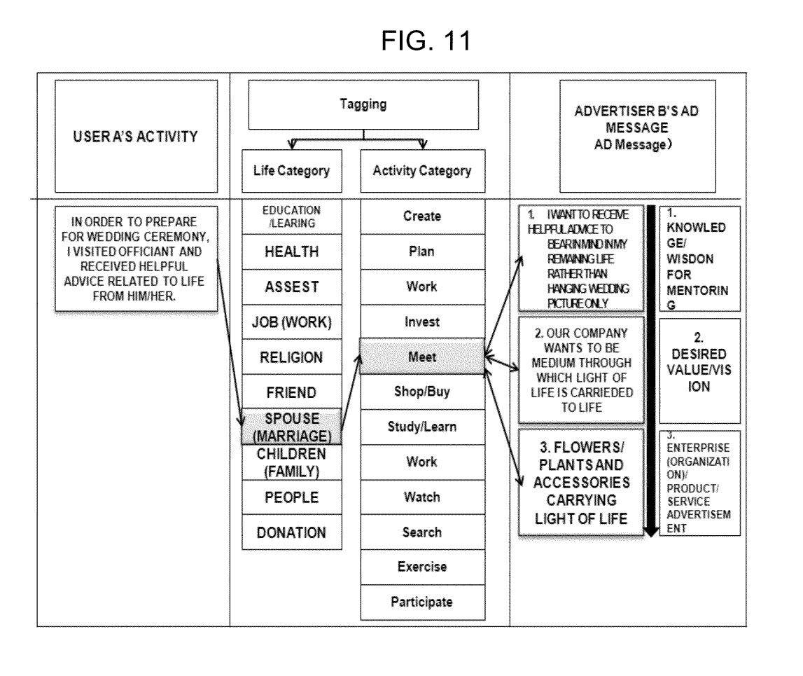

FIG. 9 is an operational flow chart of the process of creating the social interchange field in a method of providing a social network service according to a second embodiment of the present invention, and FIGS. 10 to 11 are exemplary views of screens according to a method of providing a social network service according to a second embodiment of the present invention.

Referring to FIG. 9, the steps S201 to S215 are performed, similar to in the first embodiment.

In the second embodiment, advertisement related information is further provided in step S217 of providing the activity information. That is, if the subscriber terminal selects viewing all activities, the information providing unit 313 provides recent activity information with reference to the social interchange field DB 322, and the advertisement control unit 314 simultaneously provides at least one of knowledge information, vision information, and product advertising information.

In addition, the advertisement related information is provided also in step S218 of providing the social interchange field. That is, if the subscriber terminal selects viewing all social interchange fields, the information providing unit 313 provides simple information regarding social interchange fields of all subscribers with reference to the social interchange field DB 322, and the advertisement control unit 314 simultaneously provides at least one of knowledge information, vision information, and product advertising information. In steps S217 and S218, the way of providing at least one of the knowledge information, the vision information, and the product advertising information by the advertisement control unit may make several variations. For example, a subscriber may select the knowledge information, the vision information, and the product advertising information in order or they may be sequentially provided, and it is also possible to provide detailed information regarding selected information.

Such examples are shown in FIGS. 10 and 11.

Referring to FIG. 10 or FIG. 11, a tag corresponding to an activity is displayed, knowledge information corresponding to the tag, vision information, and product advertising information are displayed on the right side.

In this case, the knowledge information is tag related knowledge information and is expertise useful for a corresponding activity. In addition, the vision information is information regarding a core value that an advertiser providing knowledge corresponding to the corresponding activity seeks, and such information is received from an advertiser or an advertisement producer and is pre-stored or such information is communicated through a real time input. In addition, advertisement information may be corresponding company (organization) or product advertisements and such advertisements may be similar to typical advertisements.

Also, in selection step S209, it is possible to select the knowledge information, the vision information, and the product advertising information 326 displayed in steps S217 and S218, unlike in the first embodiment. If a selection is made, the advertisement control unit 314 provides information selected with reference to the knowledge DB 324, the vision DB 325, and the product advertising DB 326 in step S219. It is possible to provide more detailed information and link to a web page for product purchase as needed. In addition, result information such as the number of purchases resulting from an advertisement may be separately stored in the product advertising DB 326 to feed the information back to a corresponding advertiser.

Other steps are not described in detail since they are similar to those in the first embodiment.

In the second embodiment, an advertisement is used which is associated with an activity from which the intension and interest of a social network user may be read, and the advertisement shows information required by the user step by step without focusing only on promoting a product or a service of the advertiser to increase acceptance toward the advertisement.

Since daily main activities of a social network user (subscriber) are associated with an advertisement of an advertiser, it is possible to provide economic profits to both the user (subscriber) and the advertiser and further increase social convenience.

According to embodiments of the present invention, a user may set up a goal in his/her life and put activities into practice. The user may apply other subscribers' life contents to himself/ herself while viewing them during setting up the goal or putting the activities into practice, as needed. Comments from other users may function as catalyst in changing subscribers' mind and behaviors to live happily and successfully.

In addition, by providing a ceremony corresponding to a goal achieving process, the present invention may function as catalyst for changing user's mind and behaviors to achieve his/her goal.

In addition, embodiments of the present invention enable a social network service to settle on a more future-oriented, creative, and productive on/off line space. Also, embodiments of the present invention enable the social network service to contribute to increasing social benefits as well as expanding commercial market values.

Also, the present invention is directed to a system and method for providing a social network service that enable a user and an advertiser to make bidirectional communication with an advertisement associated with an activity from which the intension and interest of a social network user may be read, and show information required by the user step by step without focusing only on promoting a product or a service of the advertiser in providing the advertisement to increase understanding on the advertiser and acceptance toward an advertisement. In addition, by associating daily main activities of a social network user (subscriber) with an advertisement of an advertiser, embodiments of the present invention may provide economic profits to both the user (subscriber) and the advertiser and further increase social convenience.

Above-describe embodiments are implemented not only through a device and a method but also through programs to execute functions corresponding to the configuration of the embodiments of the present invention or a computer readable recording medium having thereon the programs. Such implementations may be easily made by one of ordinary skill in the art from the above-described embodiments.

It will be apparent to one of ordinary skill in the art that various modifications and variations can be made in the present invention. Thus, it is intended that the present invention covers the modifications and variations of this invention provided they come within the scope of the appended claims and their equivalents.

What is claimed is:

1. A system for providing a social network service, the system being connected to at least one subscriber terminal over a network and comprising:
a subscriber profile database (DB) that stores profile information including biography, goals, and activities of the subscriber;
a social interchange field DB that stores public profile information of the subscriber profile information;
a catalyst DB that stores at least one of comment information regarding the activity and ceremony information; and
a control unit that receives a goal in life and activities to achieve the goal from the subscriber terminal, creates or updates the social interchange field of the subscriber and provides at least one of activity information, social interchange field information, comment information corresponding to the activity, and ceremony information corresponding to a goal achieving process of another user depending on a selection of the subscriber terminal.

2. The system of claim 1, wherein the control unit comprises:
a subscriber managing unit that processes an authentication of the subscriber terminal;
a social interchange field control unit that receives a goal in life and activities to achieve the goal from the subscriber terminal, and updates the social interchange field of the subscriber; and
an information providing unit that provides at least one of activity information, social interchange field information, comment information corresponding to the activity, and ceremony information corresponding to a goal achieving process of another user depending on a selection of the subscriber terminal.

3. A system for providing a social network service, the system being connected to at least one subscriber terminal over a network and comprising:
a subscriber profile DB that stores profile information including biography, goals, and activities of the subscriber;
a social interchange field DB that stores public profile information of the subscriber profile information;
a catalyst DB that stores at least one of comment information regarding the activity and ceremony information;
a knowledge DB 324 that stores knowledge information corresponding to a kind of the activities;
a vision DB that stores vision information corresponding to the knowledge information;
a product advertising DB that stores advertisement information regarding a product corresponding to the vision information; and
a control unit that receives a goal in life and activities to achieve the goal from the subscriber terminal, creates or updates the social interchange field of the subscriber, provides at least one of activity information, social interchange field information, comment information corresponding to the activity, and ceremony information corresponding to a goal achieving process of another user depending on a selection of the subscriber terminal, and provides at least one of the knowledge information corresponding to the activity, the vision information, and the product advertising information when providing the activity information.

4. The system of claim 3, wherein the control unit comprises:
a subscriber managing unit that processes an authentication of the subscriber terminal;
a social interchange field control unit that receives a goal in life and activities to achieve the goal from the subscriber terminal, and updates the social interchange field of the subscriber;
an information providing unit that provides at least one of activity information, social interchange field information, comment information corresponding to the activity, and ceremony information corresponding to a goal achieving process of another user depending on a selection of the subscriber terminal; and
an advertisement control unit that provides at least one of the knowledge information corresponding to the activity, the vision information, and the product advertising information when providing the activity information.

5. A method of providing a social network service by a social network service providing system that includes a database unit and a control and that is connected to at least one subscriber terminal over a network, the method comprising:
receiving information including subscriber's biography, goal, and activity from the subscriber by the control unit, creating a social interchange field for storing life contents, and storing the created field in the database unit;
classifying an activity by using a tag function if the activity is input from the subscriber terminal; and
updating information regarding the activity on the database unit by the control unit.

6. The method of claim 5, further comprising providing a given ceremony depending on the input activity.

7. A method of providing a social network service by a social network service providing system that includes a database unit and a control and that is connected to at least one subscriber terminal over a network, the method comprising:
providing menu information to the subscriber terminal by the control unit;
providing, by the control unit, activities of all subscribers with reference to the database unit if the subscriber terminal selects to view all activities;
providing, by the control unit, recent activities of social interchange fields of all subscribers with reference to the database unit if the subscriber terminal selects to view all social interchange fields; and
providing a social interchange field corresponding to an activity if the activity is selected.

8. The method of claim 7, further comprising receiving a comment corresponding to the activity in response to a selection of the terminal and storing the received comment in the database unit.

9. A method of providing a social network service by a social network service providing system that includes a database unit and a control and that is connected to at least one subscriber terminal over a network, the method comprising:
providing menu information to the subscriber terminal by the control unit;
providing some of at least one of activities of all subscribers, knowledge information corresponding to the activities, vision information, and product advertising information with reference to the database unit if the subscriber terminal selects to view all activities;
providing, by the control unit, some of at least one of recent activities of social interchange fields of all subscribers, knowledge information corresponding to the activities, vision information, and product advertising information with reference to the database unit if the subscriber terminal selects to view all social interchange fields; and
providing all of selected information if some of at least one of the knowledge information, the vision information, and the product advertising information are selected.

10. The method of claim 9, further comprising sequentially providing the knowledge information, the vision information, and the product advertising information, if some of at least one of the knowledge information, the vision information, and the product advertising information are selected.

11. The method of claim 10, further comprising linking to a web page for leading to a purchase procedure if purchasing is selected after the product advertising information is provided.
